(19) United States
(12) Patent Application Publication
(10) Pub. No.: US 2014/0050619 A1
(43) Pub. Date: Feb. 20, 2014

(54) Reaction Vessel

(71) Applicant: Paul Meller, Wehrheim (DE)

(72) Inventor: Paul Meller, Wehrheim (DE)

(73) Assignee: SIEMENS HEALTHCARE DIAGNOSTICS PRODUCTS GMBH, Marburg (DE)

(21) Appl. No.: 13/967,463

(22) Filed: Aug. 15, 2013

(30) Foreign Application Priority Data
Aug. 16, 2012 (EP) 12180621.0

(51) Int. Cl. G01N 35/00

(52) U.S. Cl. CPC G01N 35/00
USPC 422/63; 422/549

(57) ABSTRACT

A reaction vessel (1) with an enclosing wall (4) and an opening (6) for holding liquids to be analyzed enables particularly flexible automatic processing and, at the same time, high quality measurement results. To this end, the enclosing wall (4) comprises a first section (10), in which at least the external surface has a substantially circularly symmetric design, and a second section (12), which has at least two planar areas (14), which comprise a light-transmissive material, are opposite to one another and arranged in parallel, and wherein the reaction vessel (1) has a means (12, 22, 26) for orienting the reaction vessel (1) in a receiving position.

The invention relates to a reaction vessel with an enclosing wall and an opening for holding liquids to be analyzed. It furthermore relates to an instrument for automatic analysis of samples, comprising a device for the spatial transfer of a reaction vessel, a receiving position for receiving a reaction vessel and an optical analysis system.

These days, several detection and analysis methods for determining physiological parameters in bodily-fluid samples or biological samples are carried out automatically in large quantities in corresponding instruments. To this end, vessels, which are also referred to as cuvettes, are used which are suitable for samples, reagents and also for the actual detection reaction. These vessels usually comprise a closed enclosing wall and an optionally closable opening for receiving the respective liquid to be analyzed.

Current instruments are able to carry out a multiplicity of detection reactions and analyses using a sample. To this end, such instruments usually comprise a receiving position for a reaction vessel and an analysis system associated with the receiving position. For complicated reaction processes, comprising several process steps in succession, the sample vessel is generally repeatedly conveyed to various addition and/or reaction stations. In order to be able to carry out a multiplicity of examinations in an automated fashion, several devices for spatial transfer of the vessels, such as e.g. transfer arms, conveyor belts and rotatable conveyor wheels, are often required as well.

For multi-axis transfer arms in particular, it is often necessary in this case for the cuvettes not to have any requirements in respect of the orientation or alignment of the transfer arm. The vessels should therefore typically have a rotationally symmetric design such that the transfer arm can grip the vessel from any direction. This demand largely correlates with the conditions for a flexible, optional and, in terms of the sequence of the processing, independent system.

Many analysis systems used in such automatically operating analysis instruments are based on photometric and/or radiometric measurement principles. These methods enable the qualitative and quantitative detection of analytes in liquid samples, without having to provide additional separation steps.

Clinically relevant parameters, such as e.g. the concentration or the activity of an analyte, are often determined by virtue of an aliquot of a bodily fluid of a patient being mixed simultaneously or successively with one or more test reagents in the reaction vessel, as a result of which a biochemical reaction is started, which brings about a measurable change in an optical property of the assay mix. Photometry examines and employs the attenuation of a luminous flux when passing through an absorbing and/or scattering medium. Depending on the type of triggered biochemical or biophysical reaction, different photometric/radiometric measurement methods are used, which enable the measurement of a cloudy liquid assay mix.

To this end, use can also be made of turbidimetric methods, in which the turbidity or the optical density of a solution or dispersion (suspension) is measured on the basis of the light attenuation or absorption of a light beam passing directly through the dispersion (suspension).

Here, the above-described demand for rotationally symmetric reaction vessels, which should be suitable for automation, is found to be disadvantageous. The spherically shaped surfaces due to the rotational symmetry act as additional lenses in the optical beam paths, the imaging properties of which lenses in the case of e.g. absorption effects, diffraction effects, scattering effects and/or reflection effects possibly leading to significant changes in the result of a measurement.

In currently used systems with individual cuvettes, the aforementioned disadvantages when using geometrically isotropic cuvettes are accepted. As long as only signal difference measurements are carried out in the same cuvette, the influence of the material and its individual error portions can be at least largely compensated for. However, in the case of absolute measurements, the influences of the respectively utilized reaction vessel contribute significantly to the measurement signal.

These influences, caused merely by the geometry of the reaction vessel, time and time again lead to misunderstandings and difficulties in the evaluation and interpretation, right up to incorrect consideration of measurement results.

It is therefore an object of the invention to specify a reaction vessel and an instrument for automatic analysis of samples, which enable particularly flexible automatic processing and, by eliminating the cuvette properties, high quality measurement results at the same time.

According to the invention, the object is achieved in respect of the reaction vessel by virtue of the enclosing wall comprising a first section, in which at least the external surface has a substantially circularly symmetric design, and a second section, which has at least two planar areas, which comprise a light-transmissive material, are opposite to one another and arranged in parallel, and wherein the reaction vessel has a means for orienting the reaction vessel in a receiving position.

Here, the invention proceeds from the idea that, so as to have the desired non-influence of the optical beam path, a cross-sectional wall with a corresponding symmetry with opposing planar enclosing-wall parts is required. In order to produce a cuvette having such symmetry and, at the same time, having circular and radial symmetry, different regions of the reaction vessel should be formed, namely a region for processing the transfer systems, which is kept in a circular symmetric fashion, and a region for use in the optical system, with corresponding multiple symmetry. However, since it is the intention that the transfer system no longer prescribes an orientation of the vessel as a result of the rotational symmetry, but said orientation is required for a perpendicular (=normal) incidence of the light beam for the optical analysis, an orientation of the vessel should be made possible in the receiving position. To this end, the reaction vessel has corresponding means for orienting the reaction vessel in the receiving position.

In an advantageous embodiment, the means for orienting the reaction vessel in a receiving position comprises a recess in the base of the reaction vessel, which is provided for receiving a fitting, rotatable pin, which is attached in the receiving position. As a result, a rotatable pin, corresponding thereto, can be held in the receiving position in interlocking manner by the recess in the style of a stamp during the insertion. The recess in the base of the reaction vessel or the complementary pin, which is attached in the receiving position, can have any shape that renders it possible for the reaction vessel to experience a defined alignment as a result of the interlocking connection between pin and recess in the receiving position. By way of example, the rotatable pin can have a square, a rectangular, a triangular, a polygonal, an oval, a diamond-shaped, a star-shaped or an arrow-shaped cross section. As a result of automated active rotation of the pin, it is then possible, to the extent that it is necessary, to bring the reaction vessel into the correct position for the optical analysis, wherein the reaction vessel is aligned in such a way that two planar areas of the second section of the reaction vessel, which comprise a light-transmissive material, lie opposite to one another and are arranged in parallel, are aligned perpendicular to the beam path.

Alternatively or additionally, use can also be made of passive positioning systems. Here, the means for orienting the reaction vessel in a receiving position comprises guide grooves, which advantageously extend spirally and which are provided for holding guiding webs, which are attached in the receiving position.

In a further alternative or additional advantageous embodiment, the means for orienting the reaction vessel in a receiving position comprises guide webs, which extend spirally and which are provided for engaging in guide grooves, which are attached in the receiving position. Such guide grooves or guide webs are in this case arranged in such a way that they automatically rotate the cuvette into the desired orientation by forced guidance when they are inserted into the guide position.

Advantageously, the second section, provided for the optical beam path of the analysis device, has four planar areas, of which respectively two are arranged opposite to one another and in parallel. Additionally, the second section advantageously has a quadrilateral, more particularly square, cross section. For such an embodiment, all that is required is a rotation of at most 45 degrees from any position in order to bring the cuvette into a perpendicular alignment of the surfaces with respect to the beam path. This simplifies the alignment, and so passive positioning systems are sufficient in the case of a horizontal guide into the desired position and sufficient holding of the cuvette.

In a further advantageous embodiment, the second section has n even planar areas, with n>=4, i.e. e.g. six, eight, ten or twelve, of which respectively two areas are arranged opposite to one another and in parallel. This further reduces the required rotation, but also reduces the width of the surface suitable for the beam path.

In an advantageous embodiment, the edge which encloses the opening of the reaction vessel projects beyond the external surface of the first section of the reaction vessel. This creates a rim which offers a secure hold in any orientation for a transfer system, such as e.g. a transfer arm.

In a further advantageous embodiment, the whole reaction vessel consists of light-transmissive material. Since light-transmissive material is required in any case for the beam path in the second section, this measure enables an integral and hence particularly expedient and technically simple production of the whole reaction vessel, for example using an injection-molding method.

In respect of the instrument for the automatic analysis of samples, the object is achieved by virtue of the at least one position for holding a reaction vessel having at least one means for orienting an above-described reaction vessel, which is designed to align the reaction vessel in such a way that a beam path of the optical analysis system impinges perpendicularly on two planar areas, which lie opposite to one another and are arranged in parallel.

Advantageously, the means for orienting the reaction vessel comprises an asymmetrically shaped, rotatable pin, which is provided to engage in a fitting recess in the base of the reaction vessel.

In an alternative or additional advantageous embodiment, the means for orienting the reaction vessel comprises spirally extending guide webs, which are provided for engaging into spirally extending guide grooves, which are present on the reaction vessel.

In a further alternative or additional embodiment, the means for orienting the reaction vessel comprises spirally extending guide grooves, which are provided for holding spirally extending guide webs, which are present in the first section of the reaction vessel.

The means for orienting the reaction vessel advantageously comprises a pin which is movably mounted by means of a spring element. This enables an alignment of the reaction vessel in the second section: in the case of a quadrilateral cross section, the spring force exerts pressure on the reaction vessel with a corresponding alignment of the pin for engaging in the region of the corners of the quadrilateral, until said reaction vessel assumes the correct position.

The device for transferring a reaction vessel advantageously comprises a mechanical gripper. A circularly symmetric embodiment in the first region is particularly advantageous, particularly in the case of such grippers, which must be able to grip cuvettes in any orientation.

The advantages obtained by means of the invention in particular consist of the combination of a first and a second region with different symmetries on the reaction vessel in conjunction with means for alignment creating a reaction vessel which is optimized for both automated processing and interference-free optical measurement. The requirements in part force different geometry conditions, which can be reconciled by the present description. The required geometric conditions can be achieved in standard methods of production by means of an adapted tool production and polymer shaping (polymer injection-molding method).

The invention will be explained in more detail on the basis of a drawing. Therein:

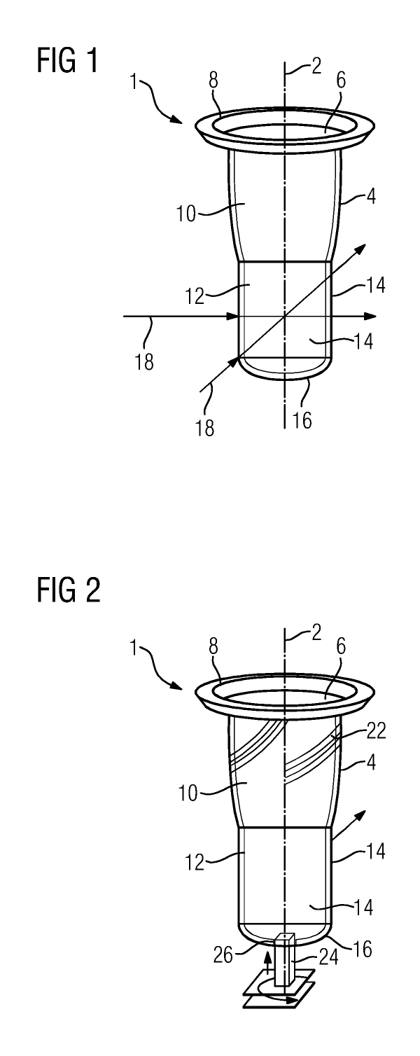

FIG. 1 shows a top view of a reaction vessel,

FIG. 2 shows a top view of a reaction vessel and part of a receiving position, and

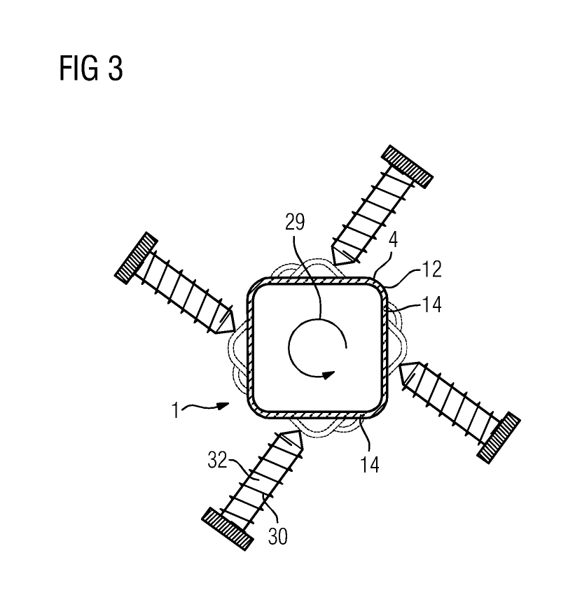

FIG. 3 shows a horizontal section of a reaction vessel and part of a receiving position.

The same parts are provided with the same reference signs in all figures.

FIG. 1 shows a top view of a reaction vessel 1. The reaction vessel 1 has a substantially rod-shaped design and has various symmetries in respect of a vertical axis 2. The reaction vessel 1 is hollow and is therefore suitable for holding liquid samples and reagents. The enclosing wall 4 of the reaction vessel 1 has an opening 6, through which the liquid samples and reagents can be filled.

In the axial direction, the reaction vessel 1 has several sections with different symmetries. Proceeding from the opening 6, which has a circular edge 8, the former is initially adjoined by a circular symmetric first section 10. The cross section thereof initially extends in a cylindrical shape along the axis 2 and then tapers. As a result of its circular symmetry, the first section is suitable to be gripped in any orientation by any conveyor system (not illustrated in any more detail) such as e.g. a transfer arm. For the secure hold of the conveyor arm or the gripper geometry, the edge 8 is designed in such a way that its outermost circumference has a greater diameter than the first section 10 adjoining thereto. As a result, the edge 8 forms an overhanging bead, which, together with the first section 10, forms a peripheral engagement depression, which can be gripped in every direction.

Adjoining the first section 10 in the axial direction is a second section 12, which, in the present exemplary embodiment, has a fourfold radial symmetry, i.e. the second section 12 is imaged on itself after in each case a quarter rotation about the axis 2. The enclosing wall 4 has four pairwise symmetric planar areas 14 in the second section, which areas are aligned in the axial direction and form a square in the horizontal cross section. Finally, the base 16, which, in the style of a cap, forms the lower termination of the reaction vessel 1, adjoins the second section 12 in the axial direction. The base 16 has a rotationally symmetric design with respect to the axis 2.

The whole reaction vessel 1 is—at least in the section 12—made of a light-transmissive polymer using an injection-molding method. A low-interference optical analysis of the liquid contained in the reaction vessel 1 is therefore possible through the planar areas 14. Here, a beam path 18 perpendicular to the surface of the areas 14, as illustrated in FIG. 1, is optimal. Hence the beam path 18 is not influenced by refraction of light.

So that the reaction vessel 1, when being inserted into a receiving position (not illustrated in any more detail in FIG. 1), has the correct alignment with respect to the beam paths 18 of the typically fixedly arranged optical analysis system, it has means for orientation which are illustrated in FIG. 2, which figure is only explained on the basis of its differences to FIG. 1.

In the exemplary embodiment according to FIG. 2, the means for orientation are formed as substantially spiral guide grooves 22 arranged in the first section 10. The guide grooves 22 engage in corresponding guide webs (not illustrated) in the receiving position. They are designed in such a way that an automatic, mechanically prompted rotation into the correct orientation in the receiving position occurs during the lowering process.

Alternatively, guide webs, which engage in guide grooves (not illustrated in any more detail) in the receiving position, can be arranged instead of the guide grooves 22. Furthermore, as part of the receiving position, a pin 24 which can be rotated about the axis 2, for example by means of an electric motor, is arranged, which pin has a preferred orientation. Said pin engages into a recess introduced into the base 16. As a result of the interlocking connection, the reaction vessel 1 can therefore be rotated arbitrarily and, in particular, into the desired orientation by rotating the pin 24.

A further alternative embodiment is shown in FIG. 3. Here, the reaction vessel 1 is illustrated in a horizontal section through the second section 12, in the direction of view of the axis 2. An arrow 29 indicates the rotation of the reaction vessel 1, wherein a plurality of rotational positions at 0 degrees, 22.5 degrees and 45 degrees are indicated in schematically superposed manner.

The means for orientation is formed on the reaction vessel 1 itself by the second section 12 itself, which has a cross section corresponding to a rounded-off square. The receiving position has four horizontally arranged pins 32, which are movably mounted by means of respectively one spring element 30. These pins are arranged in a fourfold radial symmetry with respect to the axis 2 in such a way that the alignment of the spring element points past the axis 2. They are furthermore arranged in such a way that the spring elements 30 have the maximum extension at the desired position of the reaction vessel 1 such that pressure is only exerted if the reaction vessel 1 is rotated with respect to the desired position. As a result, the reaction vessel 1 is automatically rotated into the desired position by the pressure of the spring elements 30.

The pin 24 and the pins 32 are respectively components of the receiving position (not illustrated in any more detail) of an instrument for analyzing the liquid in the reaction vessel 1. The instrument furthermore comprises the optical analysis system and a transfer arm for gripping and inserting the reaction vessel 1 into the receiving position.

In an alternative embodiment (not illustrated), the second section 12 can also have a higher order, even symmetry, e.g. six-fold, eight-fold or twelve-fold symmetry. The symmetry should be even so that two plane-parallel areas 14 are created.

### LIST OF REFERENCE SIGNS

1 Reaction vessel
2 Axis
4 Enclosing wall
6 Opening
8 Edge
10 First section
12 Second section
14 Planar area
16 Base
18 Beam path
22 Guide groove
24 Pin
26 Recess
29 Arrow
30 Spring element
32 Pin

1. A reaction vessel (1) with an enclosing wall (4) and an opening (6) for holding liquids to be analyzed, wherein the enclosing wall (4)
comprises a first section (10), in which at least the external surface has a substantially circularly symmetric design, and
a second section (12), which has at least two planar areas (14), which comprise a light-transmissive material, are opposite to one another and arranged in parallel, and wherein the reaction vessel (1) has a means (12, 22, 26) for orienting the reaction vessel (1) in a receiving position.

2. The reaction vessel (1) as claimed in claim 1, wherein the means (12, 22, 26) for orienting the reaction vessel (1) in a receiving position comprises a recess (26) in the base (16) of the reaction vessel (1), which is provided for receiving a fitting, rotatable pin (24), which is attached in the receiving position.

3. The reaction vessel (1) as claimed in claim 1, wherein the means (12, 22, 26) for orienting the reaction vessel (1) in a receiving position comprises guide grooves (22), which extend spirally and which are provided for holding guiding webs, which are attached in the receiving position.

4. The reaction vessel (1) as claimed in claim 1, wherein the means (12, 22, 32) for orienting the reaction vessel (1) in a receiving position comprises guide webs, which extend spirally and which are provided for engaging in guide grooves, which are attached in the receiving position.

5. The reaction vessel (1) as claimed in claim 1, wherein the second section (12) has four planar areas (14), of which respectively two are arranged opposite to one another and in parallel.

6. The reaction vessel (1) as claimed in claim 5, wherein the second section (12) has a quadrilateral, more particularly square, cross section.

7. The reaction vessel (1) as claimed in claim 1, wherein the second section (12) has n even planar areas (14), with n>=4, of which respectively two areas are arranged opposite to one another and in parallel.

8. The reaction vessel (1) as claimed in claim 1, wherein the edge (8) which encloses the opening (6) of the reaction vessel (1) projects beyond the external surface of the first section (10) of the reaction vessel (1).

9. The reaction vessel (1) as claimed in claim 1, wherein the whole reaction vessel (1) consists of light-transmissive material.

10. An instrument for automatic analysis of samples, comprising a device for the spatial transfer of a reaction vessel (1), a receiving position for receiving a reaction vessel (1) and an optical analysis system, wherein the at least one position for holding a reaction vessel (1) has at least one means for orienting a reaction vessel (1) as claimed in claim 1, which are designed to align the reaction vessel (1) in such a way that a beam path (18) of the optical analysis system impinges perpendicularly on two planar areas (14), which lie opposite to one another and are arranged in parallel.

11. The instrument as claimed in claim 10, wherein the means (24) for orienting the reaction vessel (1) comprises an asymmetrically shaped, rotatable pin (24), which is provided to engage in a fitting recess (26) in the base of the reaction vessel.

12. The instrument as claimed in claim 10, wherein the means for orienting the reaction vessel (1) comprises spirally extending guide webs, which are provided for engaging into spirally extending guide grooves (22), which are present on the reaction vessel (1).

13. The instrument as claimed in claim 10, wherein the means for orienting the reaction vessel (1) comprises spirally extending guide grooves, which are provided for holding spirally extending guide webs, which are present in the first section of the reaction vessel (1).

14. The instrument as claimed in claim 10, wherein the means for orienting the reaction vessel (1) comprises a pin (32) which is movably mounted by means of a spring element (30).

15. The instrument as claimed in claim 10, wherein the device for transferring a reaction vessel (1) comprises a mechanical gripper.
